(19) United States
(12) Patent Application Publication
(10) Pub. No.: US 2023/0409478 A1
(43) Pub. Date: Dec. 21, 2023

(54) METHOD AND APPARATUS TO REDUCE LATENCY OF A MEMORY-SIDE CACHE

(71) Applicant: Intel Corporation, Santa Clara, CA (US)

(72) Inventors: Kermin CHOFLEMING, Hudson, MA (US); Yu BAI, Shrewsbury, MA (US); Simon C. STEELY, JR., Hudson, NH (US)

(21) Appl. No.: 18/241,458

(22) Filed: Sep. 1, 2023

(51) Int. Cl. G06F 12/0811; G06F 12/02

(52) U.S. Cl. CPC G06F 12/0811; G06F 12/0292; G06F 2212/1021

(57) ABSTRACT

Latency on the miss path to a cache level in a CPU module is reduced by predicting when a cache miss is likely. Main memory is directly accessed in parallel with the access to the cache level in the CPU module based on the prediction that a cache miss is likely in the cache level.

### STATEMENT REGARDING FEDERALLY SPONSORED RESEARCH

This invention was made with Government support under contract number H98230-22-C-0260-0107 awarded by the Department of Defense. The Government has certain rights in this invention.

### BACKGROUND

A central processing unit (CPU) in a computer system executes instructions of a computer program. The CPU can include at least one processor core. The processor core can internally include execution units, prefetch buffers, instruction queues, branch address calculation units, instruction decoders, floating point units, retirement units, etc.

The CPU also includes multiple levels of cache organized as a hierarchy of more cache levels (L1, L2, L3, L4, etc.). A cache stores copies of data from frequently used main memory locations. The processor core includes a Level 1 (L1) cache and a Level 2 (L2) cache. The CPU can also include a level 3 (L3) cache that is shared with other processor cores in the CPU. The L1 cache, L2 cache and L3 cache can be Static Random Access Memory (SRAM).

The CPU can also include a L4 cache that can be embedded Dynamic Random Access Memory (eDRAM). L4 cache is slower and larger than the L1 cache, the L2 cache and the L3 cache. The size of the L4 cache may be multiple Giga Bytes (GB) in future process technologies.

### BRIEF DESCRIPTION OF DRAWINGS

Various examples in accordance with the present disclosure will be described with reference to the drawings, in which:

FIG. 1 is a block diagram of a system that includes a system on chip (SOC or SoC) or a System-on-Package (“SoP”);

FIG. 2 is a block diagram of the system 100 shown in FIG. 1 that includes the SoC and memory shown in FIG. 1;

FIG. 3 is a block diagram of a core-side predictor in the core;

FIG. 4 is a flowgraph illustrating a flow for a correctly predicted hit in L4 cache by the core-side predictor in the core;

FIG. 5 is a flowgraph illustrating a flow for a correctly predicted miss in L4 cache by the core-side predictor in the core;

FIG. 6 is a flowgraph illustrating a flow for an incorrectly predicted hit in L4 cache by the core-side predictor in the core; and

FIG. 7 is a flowgraph illustrating a flow for an incorrectly predicted miss in L4 cache by the core-side predictor in the core.

### DETAILED DESCRIPTION

A multiple Giga Bytes (GB) cache may be organized into address partitioned sub-caches. This organization means that misses to the large multiple GB cache will incur network latency in addition to the latency of discovering the cache miss. Network latency is the time to traverse a chip from a requesting entity to a servicing entity. A chip can be composed of many (for example, about 40-100) communicating processors and memories, each with an endpoint on the network. Traversing such a large network requires an order of a dozen cycles or more. The number of cycles to get to memory (a servicing entity) are increased by one traversal of the network for each cache level added to the chip.

As the purpose of the cache is to reduce apparent latency, the additional latency on the miss path can dilute the overall value of the multiple GB cache, especially if overall hit rate in the multiple GB cache is poor for a particular program.

Latency on the miss path is reduced by predicting when a cache miss is likely, and directly accessing the main memory in parallel with the access to a cache level based on the prediction that a cache miss is likely in the cache level. Reduction of latency on the miss path by predicting when a cache miss is likely may be applied to any two levels of a cache hierarchy,.

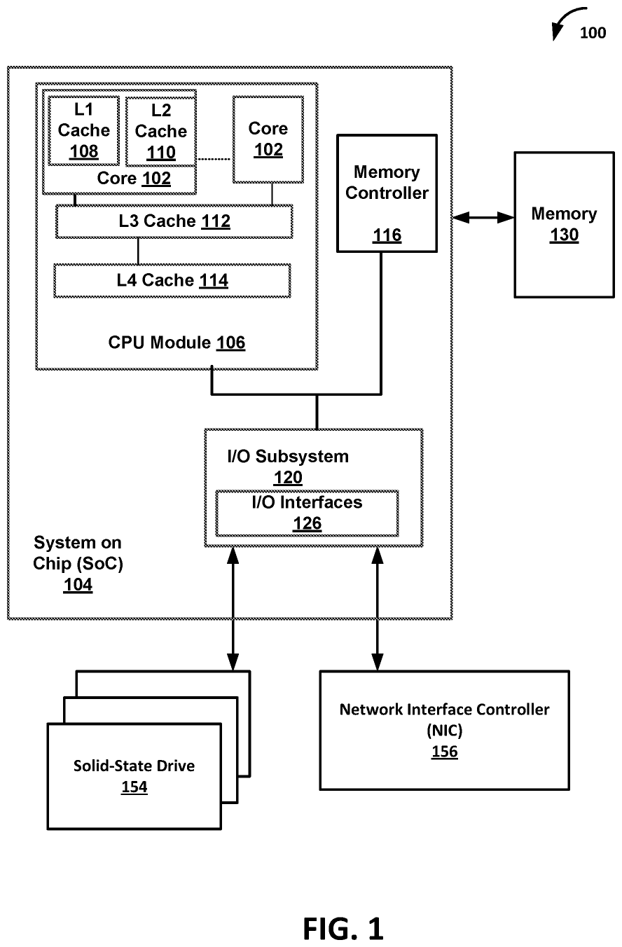

FIG. 1 is a block diagram of a system 100 that includes a system on chip (“SOC” or “SoC”) or System-on-Package (“SoP”).104.

The term System-on-a-Chip or System-on-Chip (“SoC”) can be used to describe a device or system having a processor and associated circuitry (e.g., Input/Output (“I/O”) circuitry, power delivery circuitry, memory circuitry, etc.) integrated monolithically into a single Integrated Circuit (“IC”) die, or chip. For example, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can be part of the System-on-Package (“SoP”) 104.

The SoP 104 combines processor, memory, and Input/Output (I/O) control logic into one SoP package. The SoP 104 includes at least one Central Processing Unit (CPU) module 106 and a memory controller 116. In other embodiments, the memory controller 116 can be external to the SoP 104.

The CPU module 106 includes at least one processor core 102 that includes a Level 1 (L1) cache 108 and a Level 2 (L2) cache 110. The CPU module 106 also includes a level 3 (L3) cache 112 that is shared with other processor cores 102 in the CPU module 106. The L1 cache 108, L2 cache 110 and L3 cache 112 can be Static Random Access Memory (SRAM). The CPU module 106 also includes a L4 cache 114 (level four cache) that can be embedded Dynamic Random Access Memory (eDRAM) or Static Random Access Memory (SRAM). The L2 cache 110 can also be referred to as a Mid Level Cache (MLC). The L3 cache 112 can also be referred to as a Last Level Cache (LLC). The L4 cache 114 can also be referred to as a Memory-Side Cache (MSC). The SoP 104 has a multi-level cache memory that has four levels of cache memory (Level 1 (L1) cache 108 and a Level 2 (L2) cache 110, L3 cache 112 and L4 cache 114.

Due to the non-inclusive nature of L3 cache 112, the absence of a cache line in the L3 cache 112 does not indicate that the cache line is not present in private L1 cache 108 or private L2 cache 110 of any of the processor cores 102. A snoop filter (SNF) (not shown) is used to keep track of the location of cache lines in the L1 cache 108 or L2 cache 110 when the cache lines are not allocated in the shared L3 cache 112.

Although not shown, each of the processor cores 102 can internally include execution units, prefetch buffers, instruction queues, branch address calculation units, instruction decoders, floating-point units, retirement units, etc. The CPU module 106 can correspond to a single core or a multi-core general purpose processor, such as those provided by Intel® Corporation, according to one embodiment.

Within the I/O subsystem 120, one or more I/O interface(s) 126 are present to translate a host communication protocol utilized within the processor cores 102 to a protocol compatible with particular I/O devices. Some of the protocols that I/O interfaces can be utilized for translation—include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O interface(s) 126 can communicate via the memory 130 and/or the L3 cache 112 and/or the L4 cache 114 with one or more solid-state drives 154 and a network interface controller (NIC) 156. The solid-state drives 154 can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)). In other embodiments, other storage devices, for example, other storage devices such as Hard Disk Drives (HDD) can be used instead of solid-state drives 154 and the Hard Disk Drives and/or Solid-State drives can be configured as a Redundant Array of Independent Disks (RAID).

Non-Volatile Memory Express (NVMe) standards define a register level interface for host software to communicate with a non-volatile memory subsystem (for example, solid-state drive 154) over Peripheral Component Interconnect Express (PCIe), a high-speed serial computer expansion bus. The NVM Express standards are available at www.nvmexpress.org. The PCIe standards are available at www.pcisig.com.

In an embodiment, memory 130 is volatile memory and the memory controller 116 is a volatile memory controller. Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, originally published in September 2012 by JEDEC), DDR5 (DDR version 5, originally published in July 2020), DDR6 (DDR version 6, currently in discussion by JEDEC), LPDDR3 (Low Power DDR version 3, JESD209-3B, August 2013 by JEDEC), LPDDR4 (LPDDR version 4, JESD209-4, originally published by JEDEC in August 2014), LPDDR5 (LPDDR version 5, JESD209-5A, originally published by JEDEC in January 2020), WIO2 (Wide Input/Output version 2, JESD229-2 originally published by JEDEC in August 2014), HBM (High Bandwidth Memory, JESD235, —originally published by JEDEC in October 2013), HBM2 (HBM version 2, JESD235C, originally published by JEDEC in January 2020), or HBM3 (HBM version 3 currently in discussion by JEDEC), or others or combinations of memory technologies, and technologies based on derivatives or extensions of such specifications. The JEDEC standards are available at www.jedec.org.

The processor core 102 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the processor core 102 includes logic to support a packed data instruction set architecture extension (e.g., AVX1, AVX2), thereby allowing the operations used by many multimedia applications to be performed using packed data.

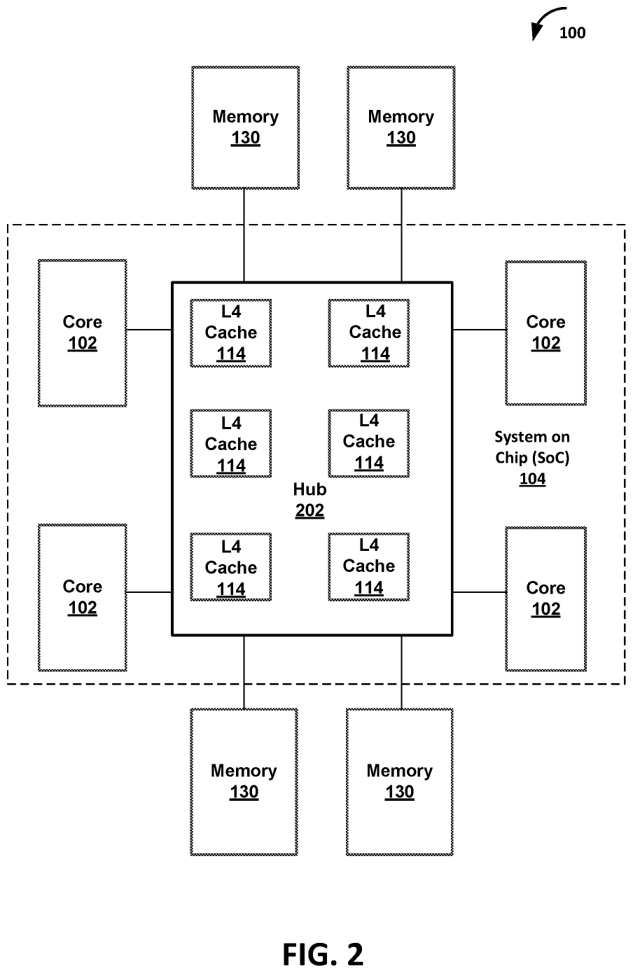

FIG. 2 is a block diagram of the system 100 shown in FIG. 1 that includes the SoP 104 and memory 130 shown in FIG. 1. The SoP 104 includes a plurality of cores 102. Each core 102 can be a discrete die, tile or chiplet. The cores 102 are communicatively coupled to a hub chip 202 that includes a plurality of L4 cache 114. Each L4 cache 114 includes a network endpoint, a cache controller and memory. In some embodiments, chip stacking (3D integration) can be used with portions of the memory and the cache controller on one of the stacked die. A Network on Chip (NoC) is used to interconnect endpoints on the hub chip 202. The hub chip 202 can also be referred to as a die, tile or chiplet.

Endpoints on the hub chip 202 can receive messages from the network and inject new messages. The decision of where to send messages is encoded in the packets traversing the network, and messages for a particular end point are steered to that endpoint. The type of messages is dependent on the device connected to the network. A memory controller can receive read and write requests and send data responses. A coherency controller (directory) can receive many different types of messages, for example, flush requests and upgrade requests and send responses for the received messages.

In a normal memory access flow, if there is a miss in L3 cache 112, a requesting agent in the L3 cache 112 sends a request to the L4 cache 114 for the data. If the requested data is not found in the L4 cache 114 (there is a miss in L4 cache 114), the requesting agent in the L4 cache 114 sends a request to the memory 130 for the data and the requested data is returned to the requesting agent in the core 102. The request to the L4 cache 114, followed by a request to the memory 130 has three network traversals and a tag lookup.

A request is sent to the hub chip 202 from a core 102. The core 102 can also be referred to as a processing chiplet. The first network traversal is from the core 102 to L4 cache 114. A tag lookup is performed in the L4 cache 114. The tag check compares the address of the data request to the addresses that are stored in the L4 cache 114. If the data is not in the L4 cache 114, the L4 cache 114 forwards a request for the address to the memory controller 116. This is the second network traversal. The memory controller 116 loads the data from memory 130. Finally, the memory controller 116 sends the data back to the core 102. This is the third network traversal. All of the three network traversals are on hub chip 202. This flow applies to most transactions between a level of the memory hierarchy and the next level of the memory, for example, between L2 cache and L3 cache.

A core-side predictor in the core 102 is used to identify which accesses are likely to miss at various levels of the memory hierarchy. In a flow in which there is a miss in L3 cache 112 and a prediction has been made by the core-side predictor that the data likely does not reside in the L4 cache 114, memory bypassing is performed by a requesting agent in the core 102. The requesting agent in the core 102 sends a request for the data to the L4 cache 114 in parallel with another request for the data to the memory 130. Sending the request to the L4 cache and the other request to the memory 130 in parallel avoids cache latency incurred by sending the request to L4 cache 114 followed by another request to the memory 130 in response to a miss in the L4 cache 114. A message is sent from the L4 cache 114 to the memory 130, informing the memory 130 to return the requested data if the requested data was not found in the L4 cache 114, or to cancel the request to return the data because the requested data was found in the L4 cache 114. The message sent from the L4 cache 114 is sent to the memory 130 in response to a message received from the core 102 by the L4 cache 114 to request the L4 cache 114 to send the message to memory 130.

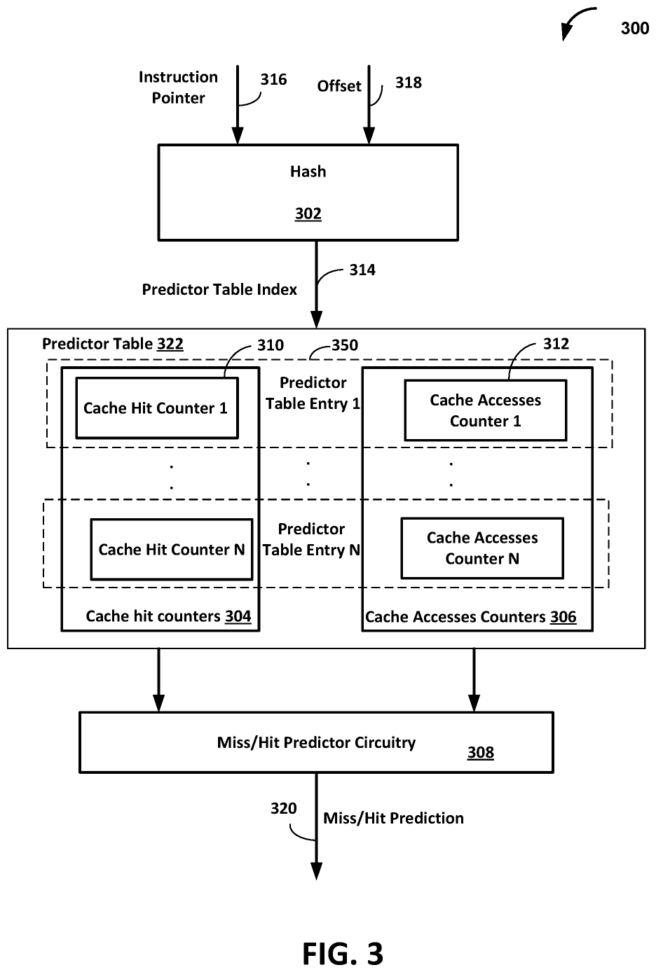

FIG. 3 is a block diagram of a core-side predictor 300 in the core 102. The core-side predictor 300 identifies memory accesses based on an instruction pointer 316 that are likely to encounter cache misses at various levels of the cache memory hierarchy. The instruction pointer 316 is the address, in memory, of the instruction that the core 102 is currently executing.

For a complex instruction set computer (CISC) architecture, the core-side predictor 300 can also include a position in the instruction or the micro-operation (offset 318). The core-side predictor 300 tracks hit rates at the granularity of instructions that access memory at the L2 cache 110 to predict whether particular accesses from the core 102 are likely to miss in the tracked level of the cache hierarchy.

In an embodiment, each L2 cache 110 in the core 102 has a core-side predictor 300. The core-side predictor 300 includes hash circuitry 302, a predictor table 322 and miss/hit predictor circuitry 308.

The core-side predictor 300 performs a hash function in hash circuitry 302 on a received instruction pointer 316 to generate a predictor table index 314. An x86 instruction can be a complex operation involving multiple memory transactions per instruction. For example, the arguments for an x86 ADD instruction can be sourced from memory or a register and thus can be a load, a store or both a load and a store. An offset 318 can be used to disambiguate among the multiple accessors to memory for a particular instruction. The hash function in hash circuitry 302 is performed on both the instruction pointer 316 and the offset 318 in the case of a complex x86 operation to generate the predictor table index 314.

The predictor table index 314 is used to index predictor table entries 350 (also referred to as rows) in the predictor table 322. The predictor table 322 is direct mapped, that is, for a given predictor table index 314 there is one predictor table entry 350 in the predictor table 322. The predictor table entry 350 in predictor table 322 is not tagged with a particular instruction. With no tagging, the predictor table entry in the predictor table 322 can be based on the behavior of several instructions.

The predictor table entry 350 includes a pair of counters (a cache hit counter 310 and a cache accesses counter 312) for a tracked level of the cache hierarchy. In the embodiment shown in FIG. 3, there are N cache hit counters 304 and N Cache Accesses Counters 306. The N cache hit counters 304 include one cache hit counter 310 in each predictor table entry 350 for the tracked level of the cache hierarchy. The N Cache Accesses Counters 306 include one cache accesses counter 312 in each predictor table entry 350 for the tracked level of the cache hierarchy. The core-side predictor 300 uses both the N cache hit counters 304 and the N cache access counters 306 to track hit rates at the granularity of instructions that access memory at the L2 cache 110 to predict whether particular accesses from the core 102 are likely to miss in the tracked level of the cache hierarchy.

Miss/hit predictor circuitry 308 receives the cache accesses value stored in the cache accesses counter 312 and the cache hit value stored corresponding cache hit counter 310 in the predictor table entry 350 selected by the predictor table index 314. The miss/hit predictor circuitry 308 divides the cache hits value (number of cache hits) stored in the cache hit counter 310 by the cache accesses value (number of cache accesses) stored in the corresponding cache accesses counter 312 and compares the result with a threshold value. If the result is greater than the threshold value a hit is predicted, if the result is less than the threshold value, a miss is predicted. The miss/hit predictor circuitry 308 outputs a miss/hit prediction 320. The miss/hit predictor circuitry 308 outputs a miss prediction on miss/hit prediction 320 if the result is less than a threshold value. The miss/hit predictor circuitry 308 outputs a hit prediction on miss/hit prediction 320 if the result is greater than the threshold value.

The cache hit counters 304 and the cache accesses counters 306 are free running. The cache hit counters 304 and the cache accesses counters 306 are updated when there is a miss at the present cache level (L2) of the cache hierarchy. If there is a hit in the tracked cache level (L4) of the cache hierarchy, the cache access counter 312 and the cache hit counter 310 are both incremented. If there is a miss in the tracked cache level, only the cache access counter 312 is incremented. A hit in the present cache level does not access the tracked cache level and is not tracked by the core-side predictor 300.

When a cache accesses counter 312 in a predictor table entry 350 is about to overflow, prior to overflow of the cache accesses counter 312, the value of the cache accesses counter 312 and the corresponding cache hit counter 310 in the predictor table entry 350 are scaled down, for example by scaling both the value stored in the cache accesses counter 312 and the value stored in the corresponding cache hit counter 310 by a same number, for example, dividing by two (a factor of 50%). As the number of bits in each cache hit counter 310 and cache accesses counter 312 in the predictor table 322 is small, the division can be performed by combinational logic or lookup tables instead of using division circuitry.

The number of bits of each cache hit counter 310 and cache accesses counter 312 in the predictor table 322 is small (for example, the counter has five bits for a maximum count of 32 accesses or six bits for a maximum count of 64 accesses). The cache hit counters 304 and the cache accesses counters 306 are free running. A six bit counter is about to overflow when the numerical value stored in the six bit counter is 63. An eight bit counter is about to overflow when the numerical value stored in the eight bit counter is 255. When a cache accesses counter 312 in a predictor table entry 350 is about to overflow, the value of the cache accesses counter 312 and the corresponding cache hit counter 310 in the predictor table entry 350 are scaled down, for example by scaling both the value stored in the cache accesses counter 312 and the value stored in the corresponding cache hit counter 310 by a factor of 50%. As the number of bits in each cache hit counter 310 and cache accesses counter 312 in the predictor table 322 is small, the division can be performed by combinational logic or lookup tables instead of using division circuitry.

A predictor table 322 with relatively few predictor table entries 350 (for example, 128 or 256 predictor table entries 350) in the predictor table 322 with each predictor table entry 350 including a cache hit counter 310 and a cache accesses counter 312 with 5-6 bits can accurately predict most cache misses. In an embodiment, a predictor table 322 that has less than 8K bits is sufficient to produce >85% prediction accuracy.

The core-side predictor 300 tracks miss rates at particular levels of the cache hierarchy, using the memory level that data was read from when data is returned to the L2 cache 110. In an embodiment, the tracked level of the cache hierarchy is L4 cache 114. The cache access counters 306 track the total accesses to L4 cache 114. The cache hit counters 304 track the total hits in L4 cache 114. When data is returned to the core 102 from memory, the data includes metadata that identifies the memory level from which the data was read (L3 cache 112, L4 cache 114, or memory 130).

If the data was read from memory 130, the access resulted in a miss in L3 cache 112 and a miss in the L4 cache 114. The cache accesses counter 312 for L4 cache 114 is incremented. The cache hit counter 310 for L4 cache 114 is not incremented because there was a miss in L4 cache 114.

If the data was read from L4 cache 114, the access resulted in a hit in L4 cache 114 and a miss in L3 cache 112. The cache accesses counter L4 cache 114 is incremented. The cache hit counter 310 for L4 cache 114 is incremented because there was a hit in L4 cache 114.

If the data was read from L3 cache 112, the access resulted in a hit in L3 cache 112. The cache accesses counter for L4 cache 114 is not incremented because there was no access to L4 cache 114. The cache hit counter 310 for L4 cache 114 is not incremented because there was not a hit in L4 cache 114.

The predictor table entry 350 in predictor table 322 is not tagged with a particular instruction. As the number of bits in the cache hit counter 310 and the cache accesses counter 312 in a predictor table entry 350 in the predictor table 322 are small (for example, 5 or 6 bits), it is more effective to add more predictor table entries 350 (for example, 3-4x) than to tag each predictor table entry 350 with a particular instruction. In other embodiments, the predictor table entry 350 in the predictor table 322 can include tags.

Hits and misses of other cache levels can be constructed using an additional cache hit counter 310 and cache access counter 312 per cache level. In another embodiment, multiple cache hierarchy levels (for example L3 cache 112 and L4 cache 114) are tracked, the predictor table 322 includes only additional cache hit counters for L3 cache 112. Hits and misses for L3 cache 112 can be constructed using the cache hit counters 304 for L4 cache 114. For example, the number of L3 cache accesses is equivalent to the sum of L4 cache accesses in the cache accesses counter 312 for L4 cache 114 and L3 cache hits in the additional cache hit counter 310 for L3 cache 112. In another embodiment, the predictor table 322 can include both additional cache hit counters and cache accesses counters for L3 cache 112.

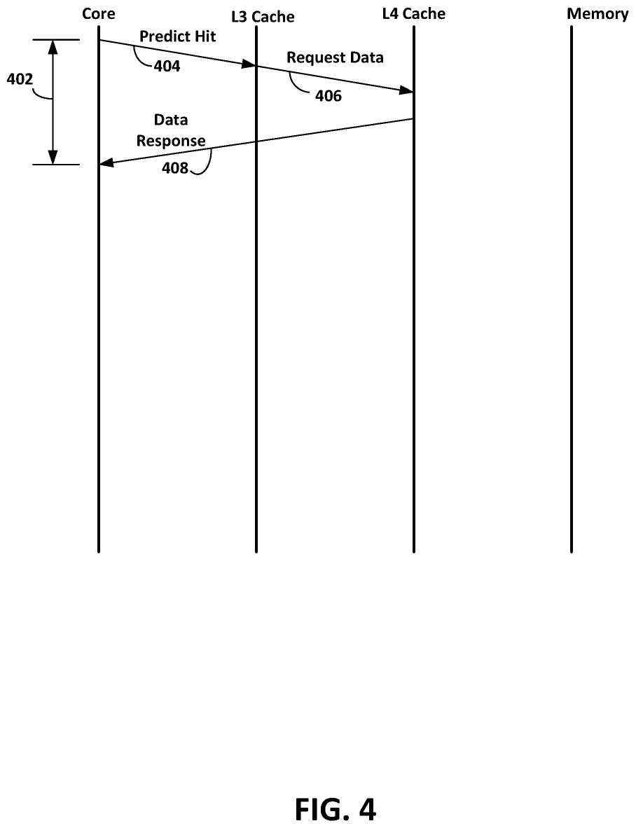

FIG. 4 is a flowgraph illustrating a flow for a correctly predicted hit in L4 cache 114 by the core-side predictor 300 in the core 102. The flow shown in FIG. 4 is the same as a flow for a baseline hit in the L4 cache and no additional messages or latency is incurred.

Based on the miss/hit prediction 320 from the core-side predictor 300, the core 102 sends a predict hit message 404 to the L3 cache 112. The L3 cache 112 sends a request data message 406 to the L4 cache 114. The L4 cache 114 sends a data response 408 to the core 102. The time from the transmission of the predict hit message 404 sent by the core 102 to the return of the data from the L3 cache 112 in data response 408 is response time 402.

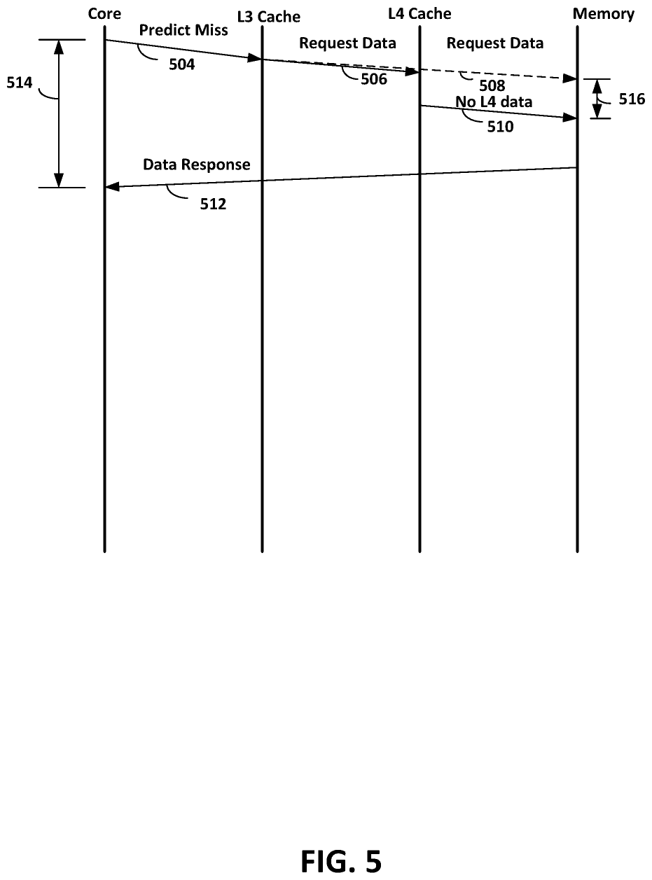

FIG. 5 is a flowgraph illustrating a flow for a correctly predicted miss in L4 cache 114 by the core-side predictor 300 in the core 102. Based on the miss/hit prediction 320 from the core-side predictor 300, the core 102 sends a predict miss request 504 to the L3 cache 112. The L3 cache 112 which includes a snoop filter (SNF) sends request data 506 to the L4 cache 114 and request data 508 to the memory 130. The requests (request data 506, request data 508) are sent to both the L4 cache 114 and the memory 130 in parallel, enabling the memory access to the memory 130 to begin in parallel with the cache access to L4 cache 114.

In response to receiving a message (no L4 data message 510) from the L4 cache 114 indicating that the requested data is not in the L4 cache 114, the memory 130 returns the requested data in data response 512 to the core 102. The time from the transmission of the predict miss request 504 sent by the core 102 to the return of the data from the memory 130 is response time 514.

The memory latency to return to data stored in the memory 130 is reduced by the time to send request data 506 to the memory 130 by the L4 cache 114 and the check for the tag in the L4 cache 114 (L4 tag check). The miss time latency 516, that is the time between the receipt of the send request data 506 by the memory 130 and the receipt of the L4 tag check by memory 130 is typically less than the time to access the data stored in memory 130 and thus there is no additional latency to return the data from the memory 130 in the case of the predicted miss to L4 cache 114.

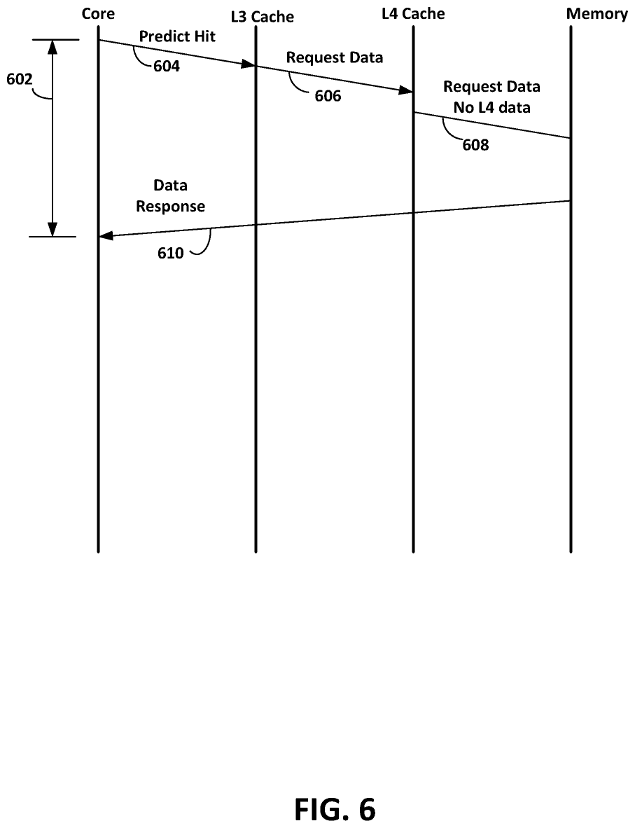

FIG. 6 is a flowgraph illustrating a flow for an incorrectly predicted hit in L4 cache by the core-side predictor 300 in the core 102. The incorrectly predicted hit in L4 cache is essentially the same as a miss in L3 cache 112 for a normal memory access flow.

Based on the miss/hit prediction 320 from the core-side predictor 300, the core 102 sends a predict hit request 604 to the L3 cache 112. The L3 cache 112 sends request data 606 to the L4 cache 114. The L4 cache 114 sends a no L4 data message 608 to the memory 130. The memory 130 returns the requested data in data response 610 to the core 102. The time from the transmission of the predict hit request 604 sent by the core 102 to the return of the data from the memory 130 is response time 602.

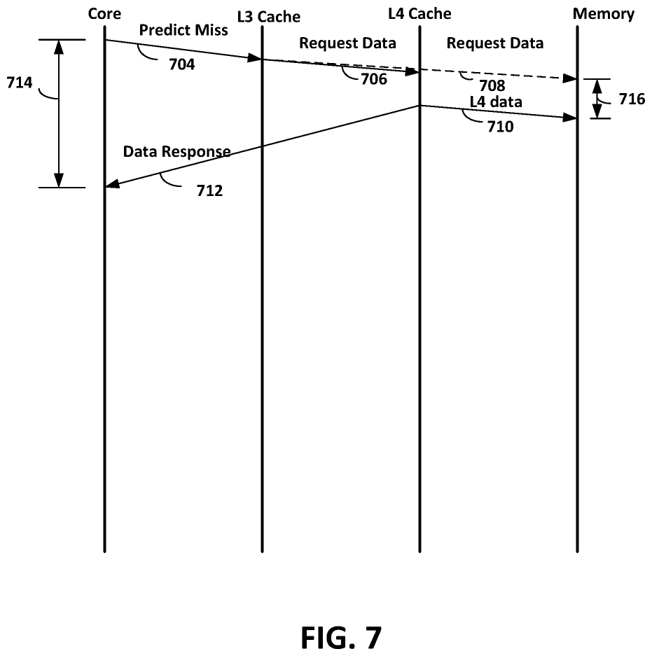

FIG. 7 is a flowgraph illustrating a flow for an incorrectly predicted miss in L4 cache by the core-side predictor 300 in the core 102. Based on the miss/hit prediction 320 from the core-side predictor 300, the core 102 sends a predict miss request 704 to the L3 cache 112. The L3 cache 112 sends request data 706 to the L4 cache 114 and request data 708 to the memory 130. The requests (request data 706, request data 708) are sent to both the L4 cache 114 and the memory 130 in parallel, enabling the memory access to the memory 130 to begin in parallel with the cache access to L4 cache 114. The L4 cache 114 returns the requested data in data response 712 to the core 102.

In response to receiving a message (L4 data message 710) from the L4 cache 114 indicating that the requested data is in the L4 cache 114, the memory controller cancels the data request to the memory 130. Depending on the latency involved, the memory controller may or may not have launched all or part of the access to memory 130. If data has been loaded by the memory controller 116 from memory 130, the data is discarded. As a result, the incorrectly predicted miss in L4 memory may result in lost memory bandwidth 716 from the memory controller 116 to the memory 130. There is no latency penalty incurred in the incorrectly predicted miss flow relative to a baseline hit, the L4 cache 114 can return data as soon as it is available. The time from the transmission of the predict miss request 704 sent by the core 102 to the return of the data from the L4 cache 114 is response time 714.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor. Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a multi-level cache memory; and
a core, the core including a core-side predictor, the core-side predictor to track a hit rate for an instruction pointer in a cache level of the multi-level cache memory to predict a cache miss in the cache level, the core to directly access a memory and the cache level of the multi-level cache memory in parallel based on a prediction that the cache miss is likely in the cache level.

2. The apparatus of claim 1, wherein the core-side predictor including a predictor table, the predictor table including a predictor table entry, the predictor table entry including a cache hit counter and a cache accesses counter for the instruction pointer in the cache level of the multi-level cache memory.

3. The apparatus of claim 2, wherein the core-side predictor includes predictor circuitry, the predictor circuitry to divide a number of cache hits stored in the cache hit counter by a number of cache accesses stored in the cache accesses counter to provide a result, the predictor circuitry to output a miss prediction if the result is less than a threshold value and to output a hit prediction if the result is greater than the threshold value.

4. The apparatus of claim 3, wherein the cache hit counter and the cache accesses counters are free running, the number of cache accesses stored in the cache accesses counter and the number of cache hits stored in the cache hit counter divided by a same number prior to overflow of the cache accesses counter.

5. The apparatus of claim 3, wherein the cache hit counter has five bits and the cache accesses counter has five bits.

6. The apparatus of claim 1, wherein the multi-level cache memory has four levels, the cache level is level four cache.

7. The apparatus of claim 6, wherein the level four cache is embedded Dynamic Random Access Memory (eDRAM) or Static Random Access Memory (SRAM).

8. A system comprising:
a memory; and
a System-on-Package communicatively coupled to the memory, the System-on-Package comprising:
a multi-level cache memory; and
a core, the core including a core-side predictor, the core-side predictor to track a hit rate for an instruction pointer in a cache level of the multi-level cache memory to predict a cache miss in the cache level, the core to directly access the memory and the cache level of the multi-level cache memory in parallel based on a prediction that the cache miss is likely in the cache level.

9. The system of claim 8, wherein the core-side predictor including a predictor table, the predictor table including a predictor table entry, the predictor table entry including a cache hit counter and a cache accesses counter for the instruction pointer in the cache level of the multi-level cache memory.

10. The system of claim 9, wherein the core-side predictor includes predictor circuitry, the predictor circuitry to divide a number of cache hits stored in the cache hit counter by a number of cache accesses stored in the cache accesses counter to provide a result, the predictor circuitry to output a miss prediction if the result is less than a threshold value and to output a hit prediction if the result is greater than the threshold value.

11. The system of claim 10, wherein the cache hit counter and the cache accesses counters are free running, the number of cache accesses stored in the cache accesses counter and the number of cache hits stored in the cache hit counter divided by a same number prior to overflow of the cache accesses counter.

12. The system of claim 10, wherein the cache hit counter has five bits and the cache accesses counter has five bits.

13. The system of claim 8, wherein the multi-level cache memory has four levels, the cache level is level four cache.

14. The system of claim 13, wherein the level four cache is embedded Dynamic Random Access Memory (eDRAM) or Static Random Access Memory (SRAM).

15. A method comprising:
tracking, by a core-side predictor in a core, a hit rate for an instruction pointer in a cache level of a multi-level cache memory to predict a cache miss in the cache level; and
directly accessing, by the core, a memory and the cache level of the multi-level cache memory in parallel based on a prediction that the cache miss is likely in the cache level.

16. The method of claim 15, wherein the core-side predictor including a predictor table, the predictor table including a predictor table entry, the predictor table entry including a cache hit counter and a cache accesses counter for the instruction pointer in the cache level of the multi-level cache memory.

17. The method of claim 16, wherein the core-side predictor includes predictor circuitry, the predictor circuitry to divide a number of cache hits stored in the cache hit counter by a number of cache accesses stored in the cache accesses counter to provide a result, the predictor circuitry to output a miss prediction if the result is less than a threshold value and to output a hit prediction if the result is greater than the threshold value.

18. The method of claim 17, wherein the cache hit counter and the cache accesses counters are free running, the number of cache accesses stored in the cache accesses counter and the number of cache hits stored in the cache hit counter divided by a same number prior to overflow of the cache accesses counter.

19. The method of claim 17, wherein the cache hit counter has five bits and the cache accesses counter has five bits.

20. The method of claim 15, wherein the multi-level cache memory has four levels, the cache level is level four cache, the level four cache is embedded Dynamic Random Access Memory (eDRAM) or Static Random Access Memory (SRAM).
